(19) United States
(12) Patent Application Publication
(10) Pub. No.: US 2023/0109428 A1
(43) Pub. Date: Apr. 6, 2023

(54) Electromagnetic Communication Enhancements Through Transparent Conductive Layers on a Substrate

(71) Applicant: SAGE Electrochromics, Inc., Faribault, MN (US)

(72) Inventors: Juha Lilja, Tampere (FI); Jean-Christophe Giron, Edina, MN (US); Robert Newcomb, Minneapolis, MN (US); Benjamin Edward Treml, Northfield, MN (US); Cody VanDerVeen, Faribault, MN (US)

(73) Assignee: SAGE Electrochromics, Inc., Faribault, MN (US)

(21) Appl. No.: 17/938,315

(22) Filed: Oct. 5, 2022

Related U.S. Application Data
(60) Provisional application No. 63/253,064, filed on Oct. 6, 2021.

(51) Int. Cl. C03C 17/23

(52) U.S. Cl. CPC C03C 17/23; B32B 17/06

(57) ABSTRACT

A device for enhanced electromagnetic communication through a coated transparent substrate is provided. The device includes a first transparent conductive (TC) layer having a first surface and a second TC layer having a second surface. The first surface is parallel to the second surface. The device also includes a first section extending through the first TC layer from the first surface and aligned with an axis that extends from the first surface to the second surface. The first section is configured to enhance electromagnetic communication through the coated transparent substrate. The device further includes a second section extending through the second TC layer from the second surface and offset from the axis that extends from the first surface to the second surface. The second section is configured to enhance electromagnetic communication through the coated transparent substrate.

### PRIORITY CLAIM

This application claims benefit of priority to U.S. Provisional Application Ser. No. 63/253,064, entitled “Electromagnetic Communication Enhancements Through Transparent Conductive Layers on a Substrate,” filed Oct. 6, 2021, and which is hereby incorporated herein by reference in its entirety.

### FIELD OF THE DISCLOSURE

The present disclosure is directed to coated transparent substrate, and more specifically to various approaches for enhancing electromagnetic communication through coated transparent substrate.

### BACKGROUND

A coated transparent substrate (e.g., a coated glass) may reduce the transmission of visible light to provide tinting or shading. A device (e.g., an electrochromic (EC) device, a photovoltaic device, a quasi-transparent device, a coated device, and the like) may be used to provide a reduction in visible light transmission through the coated transparent substrate. An EC device may include EC materials that are known to change their optical properties, such as coloration, in response to the application of an electrical potential, thereby making the coated transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied.

Typical devices (e.g., EC devices, photovoltaic devices, quasi-transparent devices, coated devices, and the like) may include one or more transparent conductive (TC) layers for communicating electricity to and/or from the other component of the device. For example, an EC device may generally include two transparent conductive (TC) layers (e.g., two transparent conductive oxide (TCO) layers) that are substantially parallel to and in contact with a counter electrode (CE) layer and an EC layer. When an electric potential is applied across the two TC layers, such as by connecting the respective TC layers to a low voltage electrical source, ions, which can include Li+ ions stored in the CE layer, flow from the CE layer, through the IC layer, and to the EC layer. In addition, electrons may flow from the CE layer, around an external circuit including a low voltage electrical source, to the EC layer so as to maintain charge neutrality in the CE layer and the EC layer. The transfer of ions and electrons to the EC layer causes the optical characteristics of the EC layer, and optionally the CE layer in a complementary EC device, to change, thereby changing the coloration and, thus, the transparency of the EC device.

However, when an electric potential is applied across the two TC layers, each of the two TC layers may inhibit or block, in addition to one or more electromagnetic visible light wave bands, one or more additional electromagnetic bands. For example, the two TC layers may impede or block electromagnetic communication bands carrying radio frequency (RF) signals. Thus, a coated transparent substrate having a device for coating the transparent substrate may impede or prevent a mobile device from receiving and/or transmitting one or more wireless transmission signals to and/or from a base station or another wireless communication device. For instance, cellular transmissions to and/or from a mobile device may be inhibited or blocked when that mobile device is within a building that utilizes a coated transparent substrate having a device for coating the transparent substrate on an exterior. However, current means to overcome this issue including using a wireless access point internal to a building and/or an intelligent reflective surface to bypass a coated transparent substrate can be costly and difficult to manage.

### SUMMARY

A coated transparent substrate (e.g., a coated glass) with enhanced electromagnetic communication transmission as described herein may include one or more sections that are formed and that extend at least partially through a device thereof. For example, a first section may be formed through a device of a coated transparent substrate. The first section may be configured to enhance electromagnetic communication of a first electromagnetic communication band through the coated transparent substrate. A second section may also be formed through the device of the coated transparent substrate. The second section may be configured to enhance electromagnetic communication of a second electromagnetic communication band through the coated transparent substrate. The second electromagnetic communication band may not be a same electromagnetic communication band as the first electromagnetic communication band allowing for enhanced electromagnetic communication of at least two electromagnetic communication bands through the coated transparent substrate. In some aspects, at least a portion of the first section and at least a portion of the second section may merge together or intersect with each other forming a third section. The third section may be configured to enhance electromagnetic communication of a third electromagnetic communication band through the coated transparent substrate. The third electromagnetic communication band may not be a same electromagnetic communication band as the first electromagnetic communication band and/or the second electromagnetic communication band. Forming a third section by merging at least a portion of the first section and the second section together may reduce manufacturing costs, when, for example, each of the sections are formed by ablating a surface of the device into patterns.

Generally, the one or more sections formed through the device of the coated transparent substrate may reduce or eliminate the effectiveness of the device to change its optical properties such as optical transmission, absorption, reflectance and/or emittance at the location(s) of the formed section(s). Thus, in some aspects, each of the one or more sections may be formed through the device at locations on the coated transparent substrate to reduce or minimize an amount of visible light that transmits through the coated transparent substrate. For instance, each of the one or more sections may be formed at a location that includes one or more obstructions when the coated transparent substrate is installed for use. Forming the one or more sections at location(s) on the coated transparent substrate where one or more obstructions may be located when the coated transparent substrate is installed for use may allow the device to maintain a desired level of tinting while still providing enhanced electromagnetic communication of one or more electromagnetic communication bands through the coated transparent substrate. In some aspects, each of the one or more sections may be formed only through the TC layers of the device. For instance, one or more of the sections may extend from an exterior surface of a TC layer and though the TC layer without penetrating any other layers of the device. Forming the one or more sections through only the TC layers may allow the device to maintain a desired level of tinting while still providing enhanced electromagnetic communication of one or more electromagnetic communication bands through the coated transparent substrate.

### BRIEF DESCRIPTION OF THE DRAWINGS

FIG. 1 illustrates a perspective view of an example EC system according to some aspects of this disclosure.

FIG. 2 illustrates a perspective cross-sectional view of an example system according to some aspects of this disclosure.

FIG. 3 illustrates a top view of an example coated transparent substrate according to some aspects of this disclosure.

FIG. 4 illustrates another perspective view of an example coated transparent substrate according to some aspects of this disclosure.

FIG. 5 illustrates a top view of an example coated transparent substrate according to some aspects of this disclosure.

FIG. 6A illustrates an example of the one or more sections of a device according to some aspects of this disclosure.

FIG. 6B illustrates another example of the one or more sections of a device according to some aspects of this disclosure.

FIG. 6C illustrates yet another example of the one or more sections of a device according to some aspects of this disclosure.

FIG. 7 illustrates another top view of an example coated transparent substrate according to some aspects of this disclosure.

FIG. 8 illustrates a perspective view of an example EC system according to some aspects of this disclosure.

FIG. 9 illustrates a perspective view of an example EC system according to some aspects of this disclosure.

FIG. 10 illustrates an example method for manufacturing a coated transparent substrate according to some aspects of this disclosure.

FIG. 11 illustrates another example method for manufacturing a device according to some aspects of this disclosure.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

In some aspects, a device of a coated transparent substrate may block and/or reduce electromagnetic communication of one or more electromagnetic communication bands (e.g., one or more radio frequency (RF) bands) through the coated glass. For example, a transparent conductive (TC) layer of an electrochromic (EC) device may impede or block electromagnetic communication transmissions of one or more electromagnetic communication bands through the EC device. However, one or more sections may be formed through at least a portion of the device to enhance electromagnetic communication of the one or more electromagnetic communication bands through the coated transparent substrate while maintaining a level of visible light transmission through the device to provide tinting.

Coated transparent substrates with enhanced electromagnetic communication transmission, as described herein, may involve one or more sections that are formed and that extend through a device of the coated transparent substrate. For example, a first section may be formed through a device of a coated transparent substrate. The first section may be configured to enhance electromagnetic communication of a first electromagnetic communication band through the coated transparent substrate. A second section may also be formed through the device of the coated transparent substrate. The second section may be configured to enhance electromagnetic communication of a second electromagnetic communication band through the coated transparent substrate. The second electromagnetic communication band may not be a same electromagnetic communication band as the first electromagnetic communication band allowing for enhanced electromagnetic communication of at least two electromagnetic communication bands through the coated transparent substrate. In some aspects, at least a portion of the first section and at least a portion of the second section may merge together or intersect with each other forming a third section. The third section may be configured to enhance electromagnetic communication of a third electromagnetic communication band through the coated transparent substrate. The third electromagnetic communication band may not be a same electromagnetic communication band as the first electromagnetic communication band and/or the second electromagnetic communication band. Forming a third section by merging at least a portion of the first section and the second section together may reduce manufacturing costs, when, for example, each of the sections are formed by ablating a surface of the device into patterns.

Generally, the one or more sections formed through a device of the coated transparent substrate may reduce or eliminate the effectiveness of the device to change its optical properties such as optical transmission, absorption, reflectance and/or emittance at the location(s) of the formed section(s). Thus, in some aspects, each of the one or more sections may be formed through the device at locations on the coated transparent substrate to reduce or minimize an amount of visible light that transmits through the coated transparent substrate. For instance, each of the one or more sections may be formed at a location that includes one or more obstructions when the coated transparent substrate is installed for use. Forming the one or more sections at location on the coated transparent substrate where one or more obstructions may be located when the coated transparent substrate is installed for use may allow the device to maintain a desired level of tinting while still providing enhanced electromagnetic communication of one or more electromagnetic communication bands through the coated transparent substrate. In some aspects, each of the one or more sections may be formed only through the TC layers of the device. For instance, one or more of the sections may extend from an exterior surface of a TC layer and though the TC layer without penetrating any other layers of the device. Forming the one or more sections through only the TC layers may allow the device to maintain a desired level of tinting while still providing enhanced electromagnetic communication of one or more electromagnetic communication bands through the coated transparent substrate.

In some aspects, a coated transparent substrate may include a device such as an EC device, a photovoltaic device, a quasi-transparent device, and the like for providing tinting to block or impede one or more electromagnetic visible light bands through the coated transparent substrate. In some aspects, the coated transparent substrate may be an EC system having an EC device.

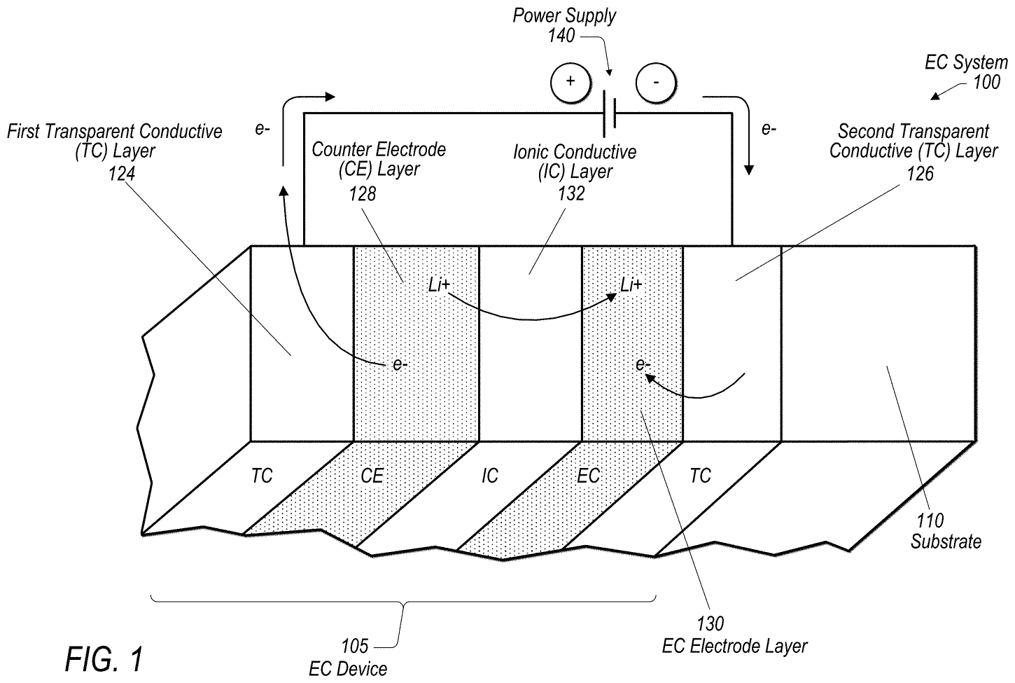

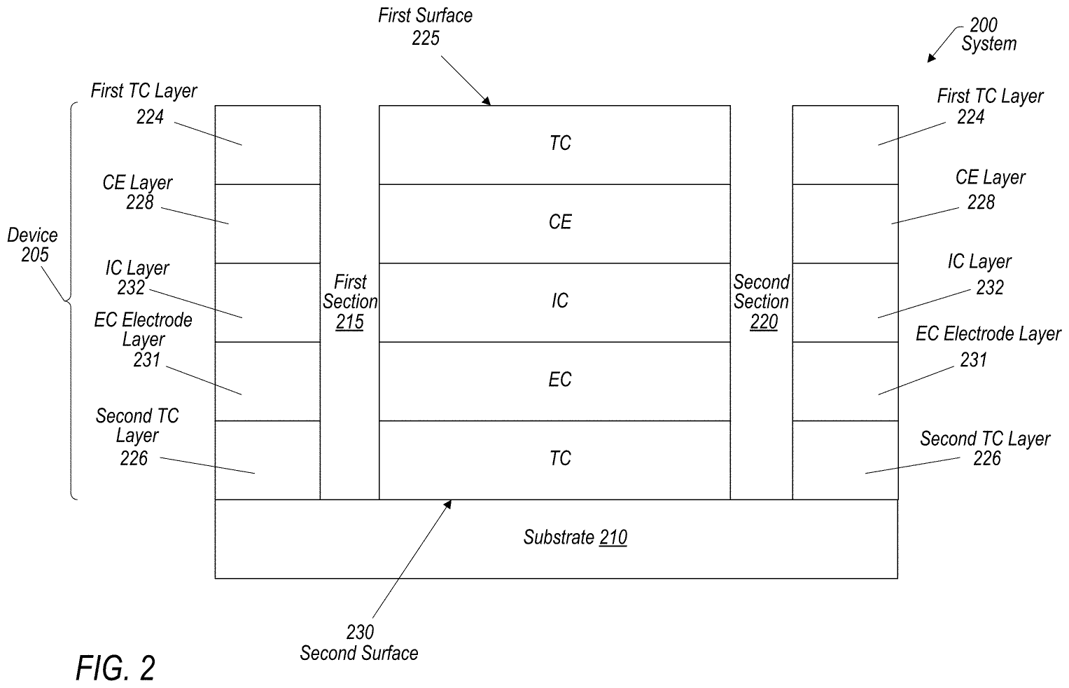

FIG. 1 illustrates a perspective view of an example EC system 100 according to some aspects of this disclosure. The EC system 100 may include one or more same or similar features as the features described with respect to or illustrated in FIGS. 2, 3, 4, 5, 6A, 6B, 6C, 7, 8, 9, 10, and 11. FIG. 1, as with the other included figures, is shown for illustrative purposes and does not limit either the possible embodiments of the present invention or the claims. In this example, the EC system 100 may include an EC device 105 secured to a substrate 110. For instance, the EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include a counter electrode (CE) layer 128 in contact with the first TC layer 124, an EC electrode layer 130 in contact with the second TC layer 126, and ionic conductor (IC) layer 132 in-between (e.g., “sandwiched” between) the CE layer 128 and the EC electrode layer 130. The EC system 100 may include a power supply 140 which may provide regulated current or voltage to the EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker—e.g., the visible light transmission of the EC device 105 may decrease. Reversing the voltage polarity may cause the lithium ions and associated charges to return to their original layer, the CE layer 128, and as a result, the EC device 105 may return to a clear state—e.g., the visible light transmission of the EC device 105 may increase.

As described herein, a device such as the EC device 105 of FIG. 1 may include one or more sections extending at least partially therethrough to enhance electromagnetic communication of one or more electromagnetic communication bands through the device and, thus, through the coated transparent substrate while maintaining a minimum amount of tinting or shading through the coated transparent substrate.

FIG. 2 illustrates a perspective cross-sectional view of an example system 200 according to some aspects of this disclosure. The system 200 may include one or more same or similar features as the features described with respect to or illustrated in FIGS. 1, 3, 4, 5, 6A, 6B, 6C, 7, 8, 9, 10, and 11. For example, the system 200 of FIG. 2 may include one or more same or similar features as the EC system 100 of FIG. 1. FIG. 2, as with the other included figures, is shown for illustrative purposes and does not limit either the possible embodiments of the present invention or the claims. In the example illustrated in FIG. 2, the system 200 may include a device 205 (e.g., a coated device) secured to a substrate 210. For instance, the device 205 may include a thin film which may be deposited on to the substrate 210. In some aspects, the device 205 may include an EC device, photovoltaic device, quasi-transparent device, or the like as discussed herein. For example, as shown in FIG. 2, the device 205 may be an EC device having a first TC layer 224, a CE layer 228, an IC layer 232, an EC electrode layer 231, and a second TC layer 226. The first TC layer 224 may include a first surface 225 forming an exterior boundary of the device 205. Similarly, the second TC layer 226 may include a second surface 230 forming another exterior boundary of the device 205. The substrate 210 may be abutting the second surface 230 of the device 205. The substrate 210 may include one or more optically transparent materials, e.g., glass, plastic, and the like. It should be understood that the system 200 may additionally, or alternatively, include another substrate that is at least similar to the substrate 210. The other substrate may be abutting a first surface 225 of the first TC layer 224.

In some aspects, the device 205 may include one or more sections for enhancing electromagnetic communication of one or more electromagnetic communication bands through the system 200. For example, the one or more sections may include at least a first section 215 and a second section 220. The first section 215 may be configured to enhance electromagnetic communication of a first electromagnetic communication band through the system 200 and the second section 220 may be configured to enhance electromagnetic communication of a second electromagnetic communication band through the system 200. In some aspects, the first section 215 may include a low-pass or all-pass topology in two cross-polarizations at the first electromagnetic communication band and the second section 220 may include a high-pass or band-pass topology in one polarization of a passband of the first section 215 at the second electromagnetic communication band. In some aspects, the first electromagnetic communication band may be a different (e.g., partially overlapping or non-overlapping) electromagnetic communication band than the second electromagnetic communication band. For example, the first electromagnetic communication band may be 600 MHz to 960 MHz and the second electromagnetic communication band may be 2600 MHz to 3800 MHz. In some aspects, each of the one or more sections may include a frequency selective surface configured to enhance electromagnetic communication of one or more desired electromagnetic communication bands through the system 200.

The one or more sections for enhancing electromagnetic communication of one or more electromagnetic communication bands through the system 200 may extend through device 205 from the first surface 225 of the device 205 to the second surface 230 of the device 205. For example, the first surface 225 may be parallel or substantially parallel to the second surface 230 and the one or more sections may extend completely through the device 205 from the first surface 225 to the second surface 230. As shown in FIG. 2, the first section 215 extends from the first surface 225, through the device 205, and to the second surface 230. Because, the first section 215 allows, for example, at least some of the first TC layer 224 and at least some of the second TC layer 226 to remain intact, an electric current may continue to communicate around the first section 215, through the first TC layer 224 and through the second TC layer 226 so that device 205 may still provide tinting. Similarly, the second section 220 extends from the first surface 225, through the device 205, and to the second surface 230. Because, the second section 220 allows, for example, at least some of the first TC layer 224 and at least some of the second TC layer 226 to remain intact, an electric current may continue to communicate around the second section 220, through the first TC layer 224 and through the second TC layer 226 so that device 205 may still provide tinting. Additionally, or alternatively, at least one section of the one or more sections may extend through the first TC layer 224 of the device 205 (e.g., without extending through any other layers of the device 205) as described further herein.

In some aspects, the one or more sections for enhancing electromagnetic communication of one or more electromagnetic communication bands through the system 200 may extend linearly through the device 205 from the first surface 225 of the device 205 to the second surface 230 of the device 205. For example, the one or more sections may extend linearly through the device 205 and in a direction that is perpendicular or substantially perpendicular to the first surface 225 and the second surface 230. As shown in FIG. 2, the first section 215 extends linearly from the first surface 225, through the device 205, and to the second surface 230 in a direction that is perpendicular or substantially perpendicular to the first surface 225 and the second surface 230. Similarly, the second section 220 extends linearly from the first surface 225, through the device 205, and to the second surface 230 in a direction that is perpendicular or substantially perpendicular to the first surface 225 and the second surface 230. Alternatively, at least one section of the one or more sections for enhancing electromagnetic communication of one or more electromagnetic communication bands through the system 200 may extend linearly through device 205 from the first surface 225 of the device 205 to the second surface 230 of the device 205 in direction that is not perpendicular to the first surface 225 or the second surface 230.

As indicated herein, the one or more sections may extend linearly through the device 205. Additionally, or alternatively, the one or more sections may each include one or more arcs, curves, or changes in direction as the one or more sections extend through the device 205. For example, at least one of the first section 215 or the second section 220 may include an arc, a curve, or a change in direction as the respective section(s) extend(s) through the device 205.

In some aspects, the one or more sections extending through the device 205 may extend through the device 205 without intersecting or overlapping with each other. For example, the first section 215 does not intersect or overlap with the second section 220 at the first surface 225, at a location within the device 205, or at the second surface 230. In some aspects, one or more sections may intersect, overlap, or merge with at least one other section to form a third or merged section, as described further herein.

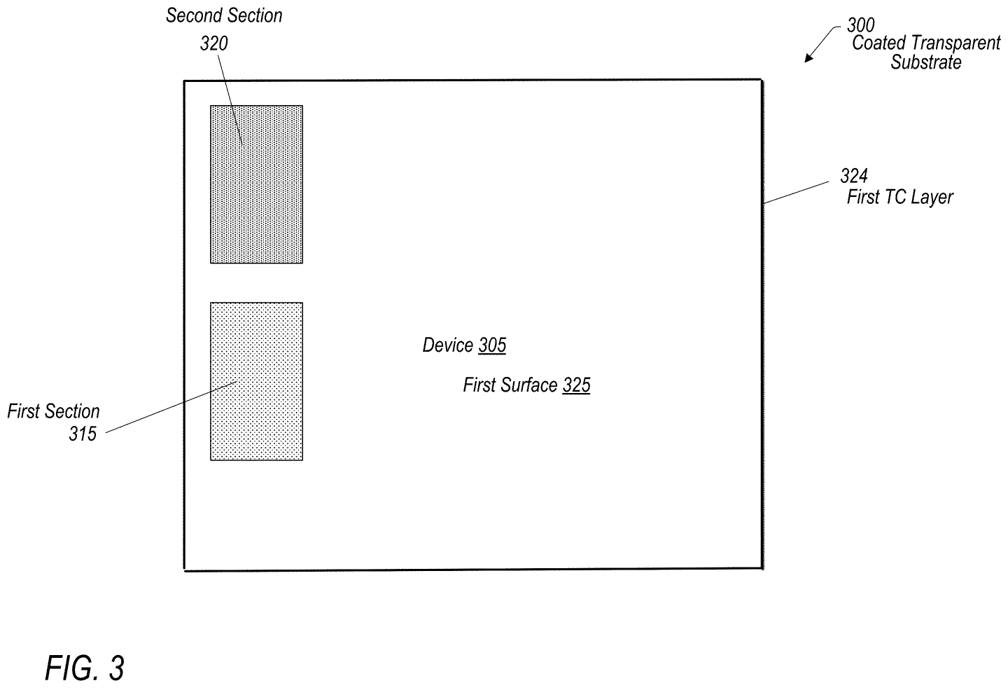

FIG. 3 illustrates a top view of an example coated transparent substrate 300 according to some aspects of this disclosure. The coated transparent substrate 300 may include one or more same or similar features as the features described with respect to or illustrated in FIGS. 1, 2, 4, 5, 6A, 6B, 6C, 7, 8, 9, 10, and 11. For example, the coated transparent substrate 300 illustrated in FIG. 3 may include one or more same or similar features as the EC system 100 illustrated in FIG. 1 and the system 200 illustrated in FIG. 2. FIG. 3, as with the other included figures, is shown for illustrative purposes and does not limit either the possible embodiments of the present invention or the claims. As shown in FIG. 3, the coated transparent substrate 300 includes a device 305 (e.g., a coated device), a first surface 325 of a first TC layer 324 forming an exterior boundary of the device 305, a first section 315 extending through the device 305, and a second section 320 extending through the device 305. It should be understood that while the first section 315 and the second section 320 have rectangular shapes, at least one of the first section 315 or the second section 320 may have a variety of different shapes including a triangular shape, a circular shape, an oval shape, a non-symmetrical shape, or the like.

At least similar to the one or more sections illustrated and described with respect to FIG. 2, the one or more sections of the coated transparent substrate 300 illustrated in FIG. 3 extend from the first surface 325 and into the device 305. Each of the one or more sections of the coated transparent substrate 300 occupy at least a fraction of a total surface area of the first surface 325. For example, the first section 315 may occupy a first surface area of the first surface 325 and the second section 320 may occupy a second surface area of the first surface 325. In some aspects, the first surface area may have a same or similar surface area as the second surface area. In some aspects, the first surface area may have a different surface area compared to the second surface area. For example, the first surface area may be larger or smaller than the second surface area. As another example, the first surface area may be twice as large or twice as small as the second surface area.

Further, as described herein, the one or more sections may extend from the first surface 325, through the device 305, and to the second surface (e.g., not shown in FIG. 3, the second surface 230 illustrated in FIG. 2). In some aspects, each of the one or more sections of the coated transparent substrate 300 may occupy at least a fraction of a total surface area of the second surface. For example, the first section 315 may occupy a first surface area on the second surface and the second section 320 may occupy a second surface area on the second surface. In some aspects, the first surface area on the second surface may have a same or similar surface area as the second surface area on the second surface. In some aspects, the first surface area may have a different surface area compared to the second surface area. For example, the first surface area on the second surface may be larger or smaller than the second surface area on the second surface. As another example, the first surface area on the second surface may be twice as large or twice as small as the second surface area on the second surface.

In addition, in some aspects, the first surface area on the second surface may be a same or similar size surface area as the first surface area on the first surface 325. Similarly, the second surface area on the second surface may be a same or similar size surface area as the second surface area on the first surface 325. Alternatively, the first surface area on the second surface may be a different size surface area compared to the first surface area on the first surface 325. Similarly, the second surface area on the second surface may be a different size surface area compared to the second surface area on the first surface 325. The total surface area of the one or more sections on the first surface 325 and/or on the second surface of the device 305, or an average, maximum, or minimum cross-sectional area of the one or more sections extending through the device 305 should be of area large enough to allow the one or more sections to enhance electromagnetic communication of the respective electromagnetic communication bands while also maintaining a minimum amount of tinting or shading effect through the coated transparent substrate 305. For example, the total surface area of the one or more sections on the first surface 325 and/or on the second surface of the device 305, or an average, maximum, or minimum cross-sectional area of the one or more sections extending through the device 305 may be no greater than 50% of the total surface area of the first surface 325, the total surface area of the second surface, or a total cross section area of the device 305.

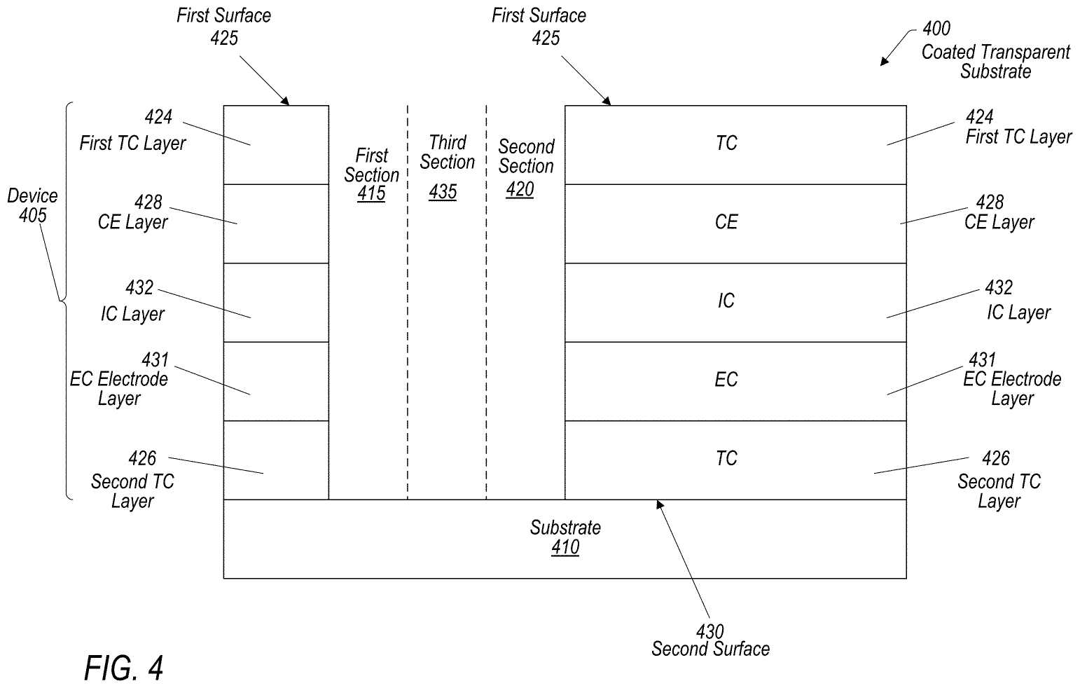

FIG. 4 illustrates another perspective view of an example coated transparent substrate 400 according to some aspects of this disclosure. The coated transparent substrate 400 may include one or more same or similar features as the features described with respect to or illustrated in FIGS. 1, 2, 3, 5, 6A, 6B, 6C, 7, 8, 9, 10, and 11. For example, the coated transparent substrate 400 illustrated in FIG. 4 may include one or more same or similar features as the EC system 100 illustrated in FIG. 1, the system 200 illustrated in FIG. 2, and the coated transparent substrate 300 illustrated in FIG. 3. FIG. 4, as with the other included figures, is shown for illustrative purposes and does not limit either the possible embodiments of the present invention or the claims. As shown in FIG. 4, the system 400 may include a device 405 (e.g., a coated device) secured to a substrate 410. The device 405 may include a thin film which may be deposited on to the substrate 410. In some aspects, the device 405 may include an EC device, photovoltaic device, quasi-transparent device, or the like as discussed herein. In some aspects, as shown in FIG. 4, the device 405 may be an EC device having a first TC layer 424, a CE layer 428, an IC layer 432, an EC electrode layer 431, and a second TC layer 426. The first TC layer 424 may include a first surface 425 forming an exterior boundary of the device 405. Similarly, the second TC layer 426 may include a second surface 430 forming another exterior boundary of the device 405. The substrate 410 may be abutting the second surface 430 of the device 405. The substrate 410 may include one or more optically transparent materials, e.g., glass, plastic, and the like. It should be understood that the system 400 may additionally, or alternatively, include another substrate that is at least similar to the substrate 410. The other substrate may be abutting a first surface 125 of the first TC layer 424.

In some aspects, the device 405 may include one or more sections for enhancing electromagnetic communication of one or more electromagnetic communication bands through the system 400. For example, the device 405 may include a first section 415 extending through the device 405, and a second section 420 extending through the device 405. In addition, the coated transparent substrate 400 includes a merged or third section 435 extending through the device 405. The third section 435 may be positioned at a location including at least one of a location on the first surface 425 of the device 405, a location within the first TC layer 424, a location within the second TC layer 426, or a location on the second surface 430 of the device 405 where at least a portion of the first section 415 and a portion of the second section 420 intersect, overlap, or merge.

For example, as shown in FIG. 4 and similar to FIG. 2, the first section 415 extends from the first surface 425, through the device 405, and to the second surface 430. The second section 420 also extends from the first surface 425, through the device 405, and to the second surface 430. Both the first section 415 and the second section 420 linearly extend in a direction perpendicular to the first surface 425 and the second surface 430. The first section 415 and the second section 420 are merged at least partially together to form the third section 435. Like the first section 415 and the second section 420, the third section 435 linearly extends from the first surface 425, through the device 405, and to the second surface 430 and in a direction that is parallel with the first section 415 and the second section 420.

As described herein, the third section 435 may be positioned at a location including at least one of a location on the first surface 425 of the device 405, a location within the first TC layer 424, a location within the second TC layer 426, or a location on the second surface 430 of the device 405 where at least the first section 415 and the second section 420 intersect, overlap, or merge. For example, as shown in FIG. 4, the third section 435 is located from the first surface 425, through the device 405 including the first TC layer 424 and the second TC layer 426, and to the second surface 430. In some aspects, at least one of the first section 415 or the second section 420 may extend linearly but in a direction that is not perpendicular to the first surface 425 and/or the second surface 430. In this case, the first section 415, at least partially merging with the second section 420, may form the third section 435 at a location including at least one of the first surface 425 or the second surface 430 and at least a portion of the first TC layer 424 and/or the second TC layer 426 between the first surface 425 and the second surface 430. In some aspects, at least one of the first section 415 or the second section 420 may each include one or more arcs, curves, or changes in direction as the one or more sections extend through the device 405. In this case, the first section 415, at least partially merging with the second section 420, may form the third section 435 at a location including at least a location within the first TC layer 424 and/or the second TC layer 426 that is between and/or includes at least one of the first surface 425 or the second surface 430.

The first section 415, at least partially merging with the second section 420, may form the third section 435 so that the third section 435 is configured to enhance electromagnetic communication of a third electromagnetic communication band through the coated transparent substrate 400. In some aspects, the third electromagnetic communication band may overlap with or contain one or more electromagnetic communication frequencies that are shared by at least one of the first electromagnetic communication band or the second electromagnetic communication band. Alternatively, the third electromagnetic communication band may be an electromagnetic communication band that does not share any electromagnetic communication frequencies with the first electromagnetic communication band and the second electromagnetic communication band. In some aspects, the third electromagnetic communication band may comprise an electromagnetic communication band of 1700 MHz to 1900 MHz.

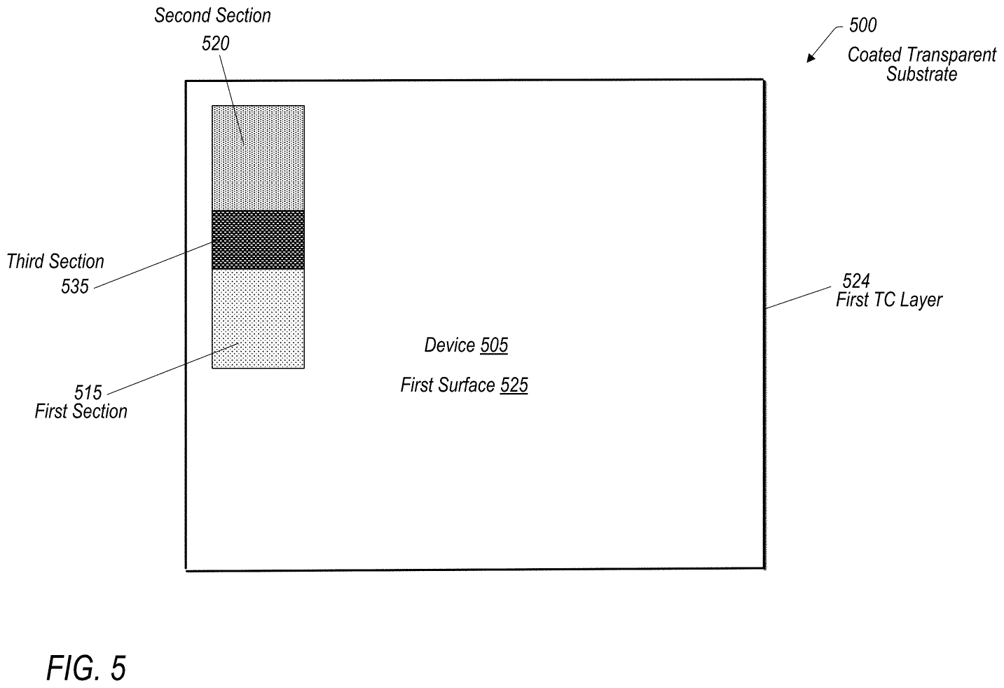

FIG. 5 illustrates a top view of an example coated transparent substrate 500 according to some aspects of this disclosure. The coated transparent substrate 500 may include one or more same or similar features as the features described with respect to or illustrated in FIGS. 1, 2, 3, 4, 6A, 6B, 6C, 7, 8, 9, 10, and 11. For example, the coated transparent substrate 500 illustrated in FIG. 5 may include one or more same or similar features as the EC system 100 illustrated in FIG. 1, the coated system 200 illustrated in FIG. 2, the coated transparent substrate 300 illustrated in FIG. 3, and the coated transparent substrate 400 illustrated in FIG. 4. FIG. 5, as with the other included figures, is shown for illustrative purposes and does not limit either the possible embodiments of the present invention or the claims. As shown in FIG. 5, the coated transparent substrate 500 includes a device 505 (e.g., a coated device), a first surface 525 of a first TC layer 524 forming an exterior boundary of the device 505, a first section 515 extending through the device 505, and a second section 520 extending through the device 505. It should be understood that while the first section 515 and the second section 520 have rectangular shapes, at least one of the first section 515 or the second section 520 may have a variety of different shapes including a triangular shape, a circular shape, an oval shape, a non-symmetrical shape, or the like.

At least similar to the one or more sections illustrated and described with respect to FIG. 4, the one or more sections of the coated transparent substrate 500 illustrated in FIG. 5 extend from the first surface 525 and into the device 505. Each of the one or more sections of the coated transparent substrate 500 may occupy at least a fraction of a total surface area of the first surface 525. For example, the first section 515 may occupy a first surface area of the first surface 525 and the second section 520 may occupy a second surface area of the first surface 525. In some aspects, the first surface area may have a same or similar surface area as the second surface area. In some aspects, the first surface area may have a different surface area compared to the second surface area. For example, the first surface area may be larger or smaller than the second surface area. As another example, the first surface area may be twice as large or twice as small as the second surface area.

Further, as described herein, the one or more sections may extend from the first surface 525, through the device 505, and to the second surface (e.g., not shown in FIG. 5, the second surface 430 illustrated in FIG. 4). In some aspects, each of the one or more sections of the coated transparent substrate 500 occupy at least a fraction of a total surface area of the second surface. For example, the first section 515 may occupy a first surface area on the second surface and the second section 520 may occupy a second surface area on the second surface. In some aspects, the first surface area on the second surface may have a same or similar surface area as the second surface area on the second surface. In some aspects, the first surface area may have a different surface area compared to the second surface area. For example, the first surface area on the second surface may be larger or smaller than the second surface area on the second surface. As another example, the first surface area on the second surface may be twice as large or twice as small as the second surface area on the second surface.

In addition, in some aspects, the first surface area on the second surface area may be a same or similar size surface area as the first surface area on the first surface 525. Similarly, the second surface area on the second surface may be a same or similar size surface area as the second surface area on the first surface 525. Alternatively, the first surface area on the second surface may be a different size surface area compared to the first surface area on the first surface 525. Similarly, the second surface area on the second surface may be a different size surface area compared to the second surface area on the first surface 525. The total surface area of the one or more sections on the first surface 525 and/or on the second surface of the device 505, or an average, maximum, or minimum cross-sectional area of the one or more sections extending through the device 505 may be of an area large enough to allow the one or more sections to enhance electromagnetic communication of the respective electromagnetic communication bands while also maintaining a minimum amount of tinting or shading effect through the coated transparent substrate 505. For example, the total surface area of the one or more sections on the first surface 525 and/or on the second surface of the device 505, or an average, maximum, or minimum cross-sectional area of the one or more sections extending through the device 505 may be no greater than 50% of the total surface area of the first surface 525, the total surface area of the second surface, or a total cross section area of the device 505.

In addition, the coated transparent substrate 500 may include a merged or third section 535 extending from the first surface 525 and at least partially through the device 505. The third section 535 may include one or more of the same or similar features described herein with respect to the third section 435 illustrated in FIG. 4. It should be understood that while the first section 515, the second section 520, and the third section 535 have rectangular shapes, at least one of the first section 515, the second section 520, or the second section 535 may have a variety of different shapes including a triangular shape, a circular shape, an oval shape, a non-symmetrical shape, or the like.

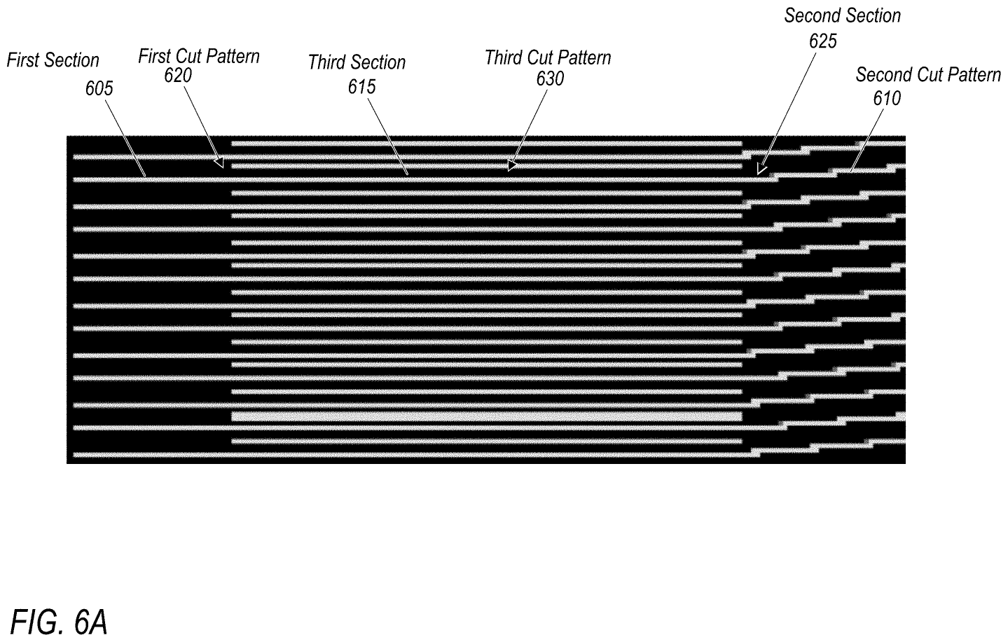

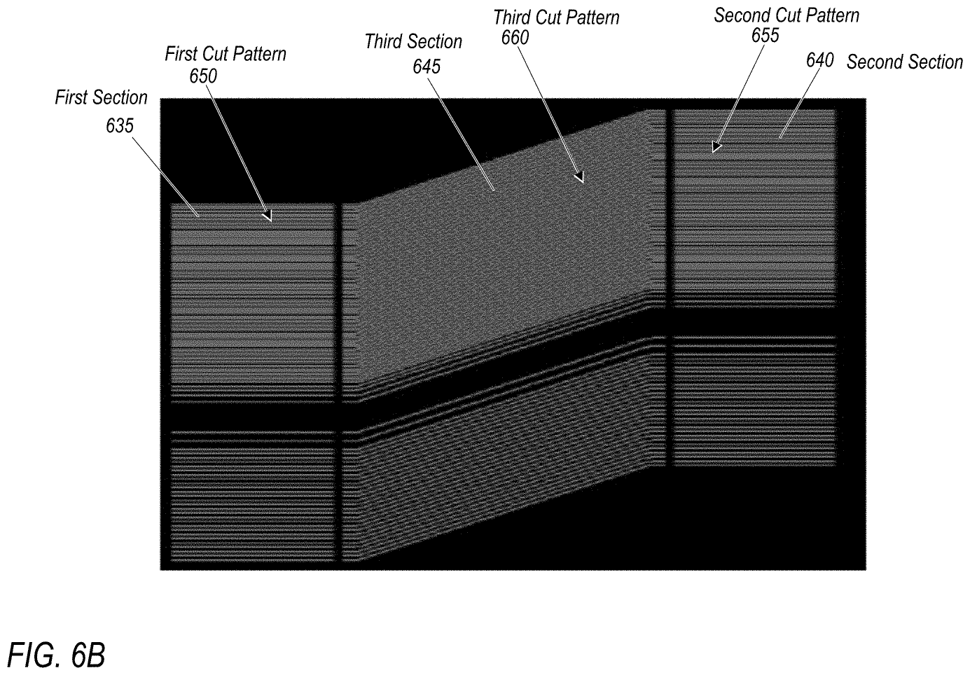

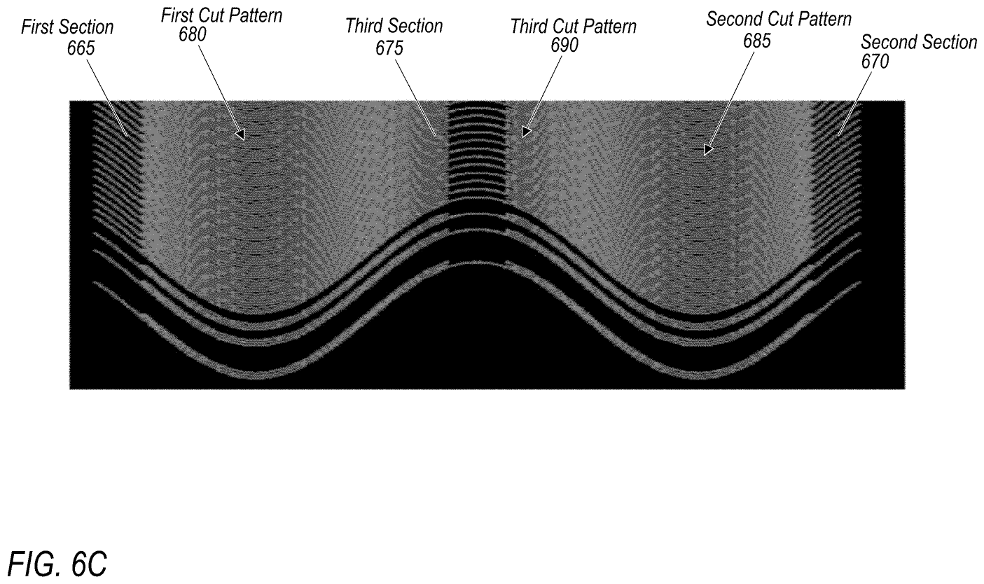

FIG. 6A illustrates an example of the one or more sections of a device (e.g., a coated device) according to some aspects of this disclosure. The device may include one or more same or similar features as the features described with respect to or illustrated in FIGS. 1, 2, 3, 4, 5, 6B, 6C, 7, 8, 9, 10, and 11. FIG. 6A, as with the other included figures, is shown for illustrative purposes and does not limit either the possible embodiments of the present invention or the claims. In some aspects, at least one of the one or more sections includes one or more cuts or ablations forming a cut pattern extending through a device (e.g., a TC layer of a device). For example, at least one cut (e.g., formed using a laser) of the one or more cuts may extend across at least a portion of a TC layer and in a direction (e.g., parallel, substantially parallel) along a direction of a current flow through the TC layer to maintain a level of tinting through the device. In some aspects, the one or more cuts may completely remove the device to form a section. As another example, as shown in FIG. 6A, a first section 605 may include one or more cuts forming a first cut pattern 620 that extends through a device, a second section 610 may include one or more cuts forming a second cut pattern 625 that extends through a device, and a third section 615 may include one or more cuts forming a third cut pattern 630 that extends through a device. The first cut pattern 620 may configure the first section 605 to enhance electromagnetic communication of a first electromagnetic communication band through a coated transparent substrate. As shown in FIG. 6A, the one or more cuts forming the first cut pattern 620 may include one or more linear cuts across the first section 605. The second cut pattern 625 may configure the second section 610 to enhance electromagnetic communication of a second electromagnetic communication band through a coated transparent substrate. As shown in FIG. 6A, the one or more cuts forming the second cut pattern 625 may include one or more jagged, non-linear cuts across the second section 610. The third cut pattern 630 may include a merger of the first cut pattern 620 and the second cut pattern 625. The third cut pattern 630 may configure the third section 615 to enhance electromagnetic communication of a third electromagnetic communication band through a coated transparent substrate. As shown in FIG. 6A, the one or more cuts forming the third cut pattern 630 may include the result of a merger between the one or more cuts forming the first cut pattern 620 and the one or more cuts forming the second cut pattern 625.

In some aspects, the first cut pattern 620 may have a first filling factor, and the second cut pattern 625 may have a second filling factor. Each of the filling factors may indicate a percentage of the first surface 525 illustrated in FIG. 5 or the second surface 430 illustrated in FIG. 4 that is cut to form the cut patterns of the respective sections. For example, the first cut pattern 620 of the first section 605 may have a first filling factor of 15% and the second cut pattern 625 of the second section 610 may have a second filling factor of 20%. In some aspects, the first filling factor may be as great as twice the second filling factor. In some aspects, a total filling factor of at least the first filling factor and the second filling factor may be no greater than 50% of the first surface 525 illustrated in FIG. 5 or the second surface 430 illustrated in FIG. 4. In some aspects, at least one filling factor may be no greater than a maximum filling factor for optimizing the amount of electromagnetic communication (e.g., at a predetermined bandwidth range) while maintaining a level of tinting through the device.

FIG. 6B illustrates another example of the one or more sections of a device (e.g., a coated device) according to some aspects of this disclosure. The device may include one or more same or similar features as the features described with respect to or illustrated in FIGS. 1, 2, 3, 4, 5, 6A, 6C, 7, 8, 9, 10, and 11. FIG. 6B, as with the other included figures, is shown for illustrative purposes and does not limit either the possible embodiments of the present invention or the claims. In some aspects, at least one of the one or more sections includes one or more cuts or ablations forming a cut pattern extending through a device (e.g., a TC layer of a device). For example, the one or more cuts may completely remove the device to form a section. As another example, as shown in FIG. 6B, a first section 635 may include one or more cuts forming a first cut pattern 650 that extends through a device, a second section 640 may include one or more cuts forming a second cut pattern 655 that extends through a device, and a third section 645 may include one or more cuts forming a third cut pattern 660 that extends through a device. The first cut pattern 650 may configure the first section 635 to enhance electromagnetic communication of a first electromagnetic communication band through a coated transparent substrate. As shown in FIG. 6B, the one or more cuts forming the first cut pattern 650 may include one or more linear cuts across the first section 635. The second cut pattern 655 may configure the second section 640 to enhance electromagnetic communication of a second electromagnetic communication band through a coated transparent substrate. As shown in FIG. 6B, the one or more cuts forming the second cut pattern 655 may include one or more different linear cuts across the second section 640. The third cut pattern 660 may comprise a merger of the first cut pattern 650 and the second cut pattern 655. The third cut pattern 660 may configure the third section 645 to enhance electromagnetic communication of a third electromagnetic communication band through a coated transparent substrate. As shown in FIG. 6B, the one or more cuts forming the third cut pattern 660 may include the result of a merger between the one or more cuts forming the first cut pattern 650 and the one or more cuts forming the second cut pattern 655.

In some aspects, the first cut pattern 650 may have a first filling factor, and the second cut pattern 655 may have a second filling factor. Each of the filling factors may indicate a percentage of the first surface 525 illustrated in FIG. 5 or the second surface 430 illustrated in FIG. 4 that is cut to form the cut patterns of the respective sections. For example, the first cut pattern 650 of the first section 635 may have a first filling factor of 15% and the second cut pattern 655 of the second section 640 may have a second filling factor of 20%. In some aspects, the first filling factor may be as great as twice the second filling factor. In some aspects, a total filling factor of at least the first filling factor and the second filling factor may be no greater than 50% of the first surface 525 illustrated in FIG. 5 or the second surface 430 illustrated in FIG. 4. In some aspects, at least one filling factor may be no greater than a maximum filling factor for optimizing the amount of electromagnetic communication (e.g., at a predetermined bandwidth range) while maintaining a level of tinting through the device.

FIG. 6C illustrates yet another example of the one or more sections of a device (e.g., a coated device) according to some aspects of this disclosure. The device may include one or more same or similar features as the features described with respect to or illustrated in FIGS. 1, 2, 3, 4, 5, 6A, 6B, 7, 8, 9, 10, and 11. FIG. 6C, as with the other included figures, is shown for illustrative purposes and does not limit either the possible embodiments of the present invention or the claims. In some aspects, at least one of the one or more sections includes one or more cuts or ablations forming a cut pattern extending through a device (e.g., a TC layer of a device). For example, the one or more cuts may completely remove the device to form a section. As another example, as shown in FIG. 6C, a first section 665 may include one or more cuts forming a first cut pattern 680 that extends through a device, a second section 670 may include one or more cuts forming a second cut pattern 685 that extends through the device, and a third section 675 may include one or more cuts forming a third cut pattern 690 that extends through the device. The first cut pattern 680 may configure the first section 665 to enhance electromagnetic communication of a first electromagnetic communication band through a coated transparent substrate. As shown in FIG. 6C, the one or more cuts forming the first cut pattern 680 may include one or more curved cuts across the first section 665. The second cut pattern 685 may configure the second section 670 to enhance electromagnetic communication of a second electromagnetic communication band through a coated transparent substrate. As shown in FIG. 6C, the one or more cuts forming the second cut pattern 685 may include one or more different curved cuts across the second section 670. The third cut pattern 690 may comprise a merger of the first cut pattern 680 and the second cut pattern 685. The third cut pattern 690 may configure the third section 675 to enhance electromagnetic communication of a third electromagnetic communication band through a coated transparent substrate. As shown in FIG. 6C, the one or more cuts forming the third cut pattern 690 may include the result of a merger between the one or more cuts forming the first cut pattern 680 and the one or more cuts forming the second cut pattern 685.

In some aspects, the first cut pattern 680 may have a first filling factor, and the second cut pattern 685 may have a second filling factor. Each of the filling factors may indicate a percentage of the first surface 525 illustrated in FIG. 5 or the second surface 430 illustrated in FIG. 4 that is cut to form the cut patterns of the respective sections. For example, the first cut pattern 680 of the first section 665 may have a first filling factor of 15% and the second cut pattern 685 of the second section 670 may have a second filling factor of 20%. In some aspects, the first filling factor may be as great as twice the second filling factor. In some aspects, a total filling factor of at least the first filling factor and the second filling factor may be no greater than 50% of the first surface 525 illustrated in FIG. 5 or the second surface 430 illustrated in FIG. 4. In some aspects, at least one filling factor may be no greater than a maximum filling factor for optimizing the amount of electromagnetic communication (e.g., at a predetermined bandwidth range) while maintaining a level of tinting through the device.

Each of the filling factors may be a function of the length of each cut and a width of each cut forming the cut patterns. For example, at least one of the cuts forming a cut pattern may be performed by a laser having an elongated focal region that has an aspect ratio that is less than 2:1. As another example, at least one of the cuts forming a cut pattern may be formed by a laser having a circular focal region that has an aspect ratio of 2:1. In some aspects, a laser may preform one or more cuts each having a width that is no greater than 15 μm.

As described herein, the one or more sections may enhance electromagnetic communication of a one or more electromagnetic communication bands through a coated transparent substrate. Also, as described herein, the one or more sections may reduce an ability of a coated transparent substrate to tint. Accordingly, in addition to or as an alternative to limiting a surface area (or cross-sectional area) of each of the one or more sections to allow the coated transparent substrate maintain a minimum amount of tinting, a position of each of the one or more sections on the first surface of the device, on the second surface of the device, or at a depth within the device may enhance electromagnetic communication of one or more electromagnetic communication bands through a coated transparent substrate while also allowing the coated transparent substrate to maintain a minimum amount of tinting. For example, at least a portion of an area of at least one section of the one or more sections may be positioned at an obstruction area of the coated transparent substrate. An obstruction area on a coated transparent substrate may include an area on the coated transparent substrate that is obstructed by another object. An obstruction area may include a position for attaching a rear-view mirror on a coated transparent substrate for use as an automobile windshield. An obstruction area may include a position for attaching a coated transparent substrate to a frame. For example, an obstruction area may include at least one of an area including at least a portion of a perimeter of the coated transparent substrate.

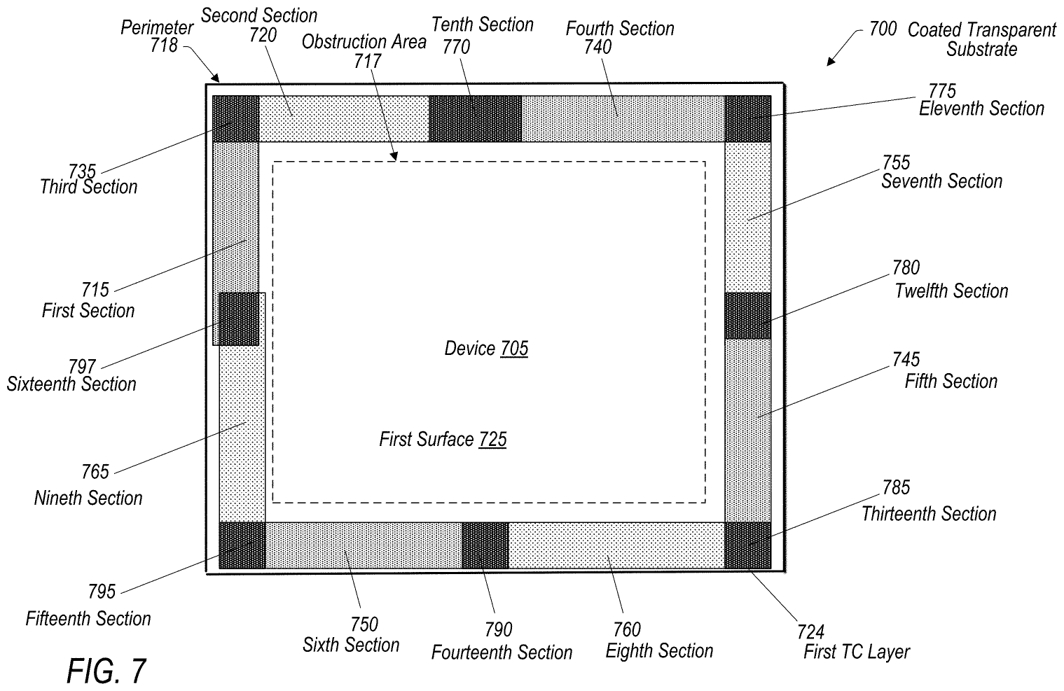

FIG. 7 illustrates another top view of an example coated transparent substrate 700 according to some aspects of this disclosure. The coated transparent substrate 700 may include one or more same or similar features as the features described with respect to or illustrated in FIGS. 1, 2, 3, 4, 5, 6A, 6B, 6C, 8, 9, 10, and 11. For example, the coated transparent substrate 700 illustrated in FIG. 7 may include one or more same or similar features as the EC system 100 illustrated in FIG. 1, the system 200 illustrated in FIG. 2, the coated transparent substrate 300 illustrated in FIG. 3, and the coated transparent substrate 400 illustrated in FIG. 4, and the coated transparent substrate 500 illustrated in FIG. 5, and the sections illustrated in FIG. 6A, FIG. 6B, and FIG. 6C. FIG. 7, as with the other included figures, is shown for illustrative purposes and does not limit either the possible embodiments of the present invention or the claims. As shown in FIG. 7, the coated transparent substrate 700 includes a device 705 (e.g., a coated device), a first surface 725 of a first TC layer 724 forming an exterior boundary of the device 705, and a plurality of section extending through the device 705. The plurality of sections may each be for enhancing electromagnetic communication of one or more electromagnetic communication bands through the coated transparent substrate. The one or more sections include a first section 715, a second section 720, a third section 735, a fourth section 740, a fifth section 745, a sixth section 750, a seventh section 755, an eighth section 760, a nineth section 765, a tenth section 770, an eleventh section 775, a twelfth section 780, a thirteenth section 785, a fourteenth section 790, a fifteenth section 795, and a sixteenth section 797.

In some aspects, each of the first section 715, the fourth section 740, the fifth section 745, and the sixth section 750 may enhance electromagnetic communication of the first electromagnetic communication band through the coated transparent substrate 700 as described herein. Similarly, each of the second section 720, the seventh section 755, the eighth section 760, and the nineth section 765 may enhance electromagnetic communication of the second electromagnetic communication band through the coated transparent substrate 700 as described herein. The third section 735, the tenth section 770, the eleventh section 775, the twelfth section 780, the thirteenth section 785, the fourteenth section 790, the fifteenth section 795, and the sixteenth section 797 may be merged or third sections that enhance electromagnetic communication of the third electromagnetic communication band through the coated transparent substrate 700 as described herein. In some aspects, at least one section of the one or more sections may enhance electromagnetic communication of an electromagnetic communication band that is different from the first electromagnetic communication band, the second electromagnetic communication band, or the third electromagnetic communication band.

In some aspects, the first surface 725 may include an obstruction area 717. As shown in FIG. 7, the obstruction area 717 may be an area including at least a portion of a perimeter 718 on the first surface 725 of the device 705. In some aspects, the obstruction area 717 may include a boundary formed at a location adjacent an edge surface of the coated transparent substrate 700. In some aspects, when the obstruction area 717 is an area including at least a portion of the perimeter 718 on the first surface 725 of the device 705, the obstruction area 717 may extend a distance from the perimeter 718 that is no greater than 50 mm.

As described herein, the one or more sections of the device may extend from a first surface of the device, through the device, and to a second surface of the device. In other words, one or more sections of a device may extend completely through the device. Additionally, or alternatively, one or more sections of the device may extend partially through the device. For example, a first section may extend completely through the device while a second section may extend only partially through the device. As another example, both the first section and the second section may extend only partially through the device. In some aspects, when a coated transparent substrate includes an electrochromic (EC) system having a device that includes an EC device, one or more sections may extend only partially through the device.

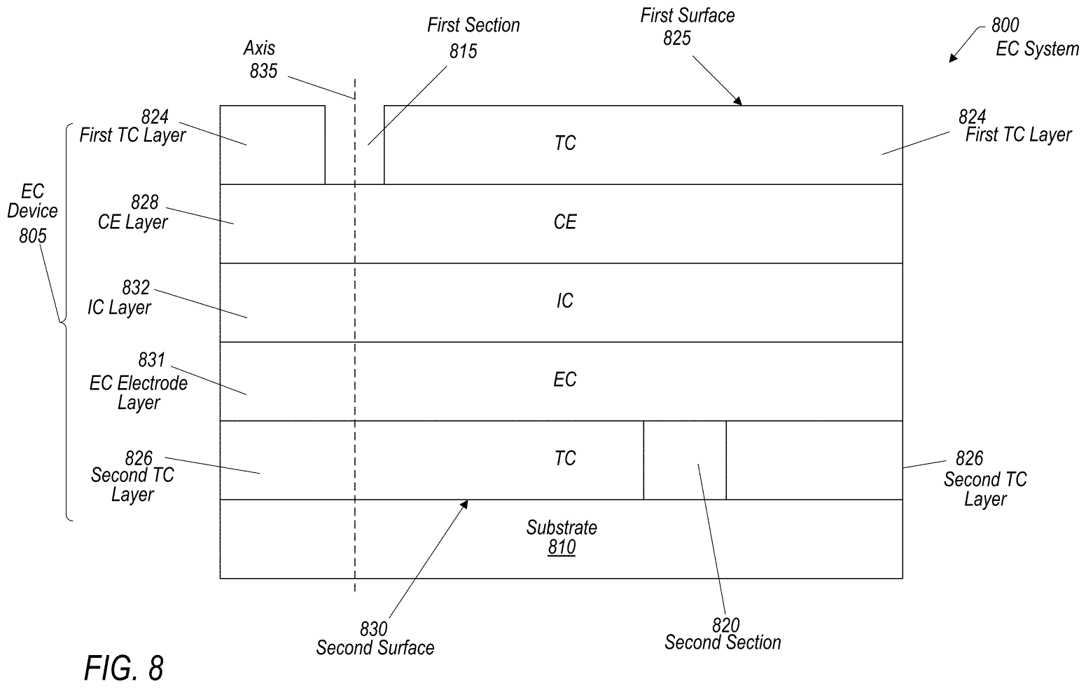

FIG. 8 illustrates a perspective view of an example EC system 800 according to some aspects of this disclosure. The EC system 800 may include one or more same or similar features as the features described with respect to or illustrated in FIGS. 1, 2, 3, 4, 5, 6A, 6B, 6C, 7, 9, 10, and 11. For example, the EC system 800 illustrated in FIG. 8 may include one or more same or similar features as the EC system 100 illustrated in FIG. 1, the system 200 illustrated in FIG. 2, the coated transparent substrate 300 illustrated in FIG. 3, and the coated transparent substrate 400 illustrated in FIG. 4, the coated transparent substrate 500 illustrated in FIG. 5, the sections illustrated in FIG. 6A, FIG. 6B, and FIG. 6C, and the coated transparent substrate 700 illustrated in FIG. 7. FIG. 8, as with the other included figures, is shown for illustrative purposes and does not limit either the possible embodiments of the present invention or the claims. In some aspects, the EC system 800 may include an EC device 805 secured to a substrate 810. The EC device 805 may include a thin film which may be deposited on to the substrate 810. As shown in FIG. 8, the EC device 805 may have a first TC layer 824, a CE layer 828, an IC layer 832, an EC electrode layer 831, and a second TC layer 826. The first TC layer 824 may include a first surface 825 forming an exterior boundary of the EC device 805. Similarly, the second TC layer 826 may include a second surface 830 forming another exterior boundary of the EC device 805. The substrate 810 may be abutting the second surface 830 of the EC device 805. The substrate 810 may include one or more optically transparent materials, e.g., transparent substrate, plastic, and the like. It should be understood that the EC system 800 may additionally, or alternatively, include another substrate that is at least similar to the substrate 810. The other substrate may be abutting a first surface 825 of the first TC layer 824.

In some aspects, the EC device 805 may include one or more sections for enhancing electromagnetic communication of one or more electromagnetic communication bands through the EC system 800. For example, the one or more sections may include at least a first section 815 and a second section 820. The first section 815 may be configured to enhance electromagnetic communication of a first electromagnetic communication band through the EC system 800 and the second section 820 may be configured to enhance electromagnetic communication of a second electromagnetic communication band through the EC system 800. In some aspects, the first electromagnetic communication band and the second electromagnetic communication band may be a same electromagnetic communication band. In some aspects, the first electromagnetic communication band and the second electromagnetic communication band may have one or more same electromagnetic communication frequencies.

In some aspects, the first electromagnetic communication band may be a different (e.g., partially overlapping or non-overlapping) electromagnetic communication band than the second electromagnetic communication band. For example, the first section 815 may include a low-pass or all-pass topology in two cross-polarizations at the first electromagnetic communication band and the second section 820 may include a high-pass or band-pass topology in one polarization of a passband of the first section 815 at the second electromagnetic communication band. As another example, the first electromagnetic communication band may be 600 MHz to 960 MHz and the second electromagnetic communication band may be 2600 MHz to 3800 MHz. In some aspects, each of the one or more sections may include a frequency selective surface configured to enhance electromagnetic communication of one or more desired electromagnetic communication bands through the EC system 800.

The at least one section of the one or more sections for enhancing electromagnetic communication of one or more electromagnetic communication bands through the EC system 800 may extend through some of the EC system 800, but not entirely through the EC system 800. For example, the first surface 825 may be parallel or substantially parallel to the second surface 830. The first section 815 may extend from the first surface 825 and at least partially through the first TC layer 824. Thus, an electric current may continue to communicate through the first TC layer 824 around the first section 815. The first section 815 may not extend into the CE layer 828. Thus, the EC device 805 may continue to provide tinting while enhancing electromagnetic communication of the first electromagnetic communication band through the first section 815. The second section 820 may extend from the second surface 830 and at least partially through the second TC layer 826. Thus, an electric current may continue to communicate through the second TC layer 826 around the second section 820. The second section 820 may not extend into the EC electrode layer 831. Thus, the EC device 805 may continue to provide tinting while enhancing electromagnetic communication of the second electromagnetic communication band through the second section 820. The first section 815 and the second section 820 may be formed using one or more cuts or ablations as described herein. In addition, or as an alternative, at least one of the first section 815 or the second section 820 may be formed using a masking process, for example, during the formation of the first TC layer 824 and the second TC layer 826, respectively.

In some aspects, as shown in FIG. 8, the first section 815 may be aligned with an axis 835 that extends through the EC system 800 in a direction that is perpendicular to the first surface 825 and/or the second surface 830. The second section 820 may be offset from the axis 835 and thus offset from the first section 815. Additionally, one or more other sections for enhancing electromagnetic communication of one or more electromagnetic communication bands through the EC system 800 may be aligned with the axis 835. Alternatively, the first section 815 and the second section may be aligned with the axis 835. Additionally, one or more other sections for enhancing electromagnetic communication of one or more electromagnetic communication bands through the EC system 800 may be aligned with the axis 835.

In some aspects, the EC system 800 may include a merged or third section (e.g., such as the third section 435 illustrated in FIG. 4. For example, the first TC layer 824 may include the first section 815 and another section adjacent the first section 815 and extending from the first surface 825 and through the first TC layer 824 like the first section 815. The other section may at least partially overlap or merge with the first section 815 to form a merged or third section. As another example, the second TC layer 826 may include the second section 820 and another section adjacent the second section 820 and extending from the second surface 830 and through the second TC layer 826 like the second section 820. The other section may at least partially overlap or merge with the second section 820 to form a merged or third section. The third section may be the same as or at least similar to the third section 435 illustrated in FIG. 4. For example, the third section may enhance electromagnetic communication of one or more electromagnetic communication bands that are different from the first electromagnetic communication band and/or the second electromagnetic communication through the EC system 800, as described herein.

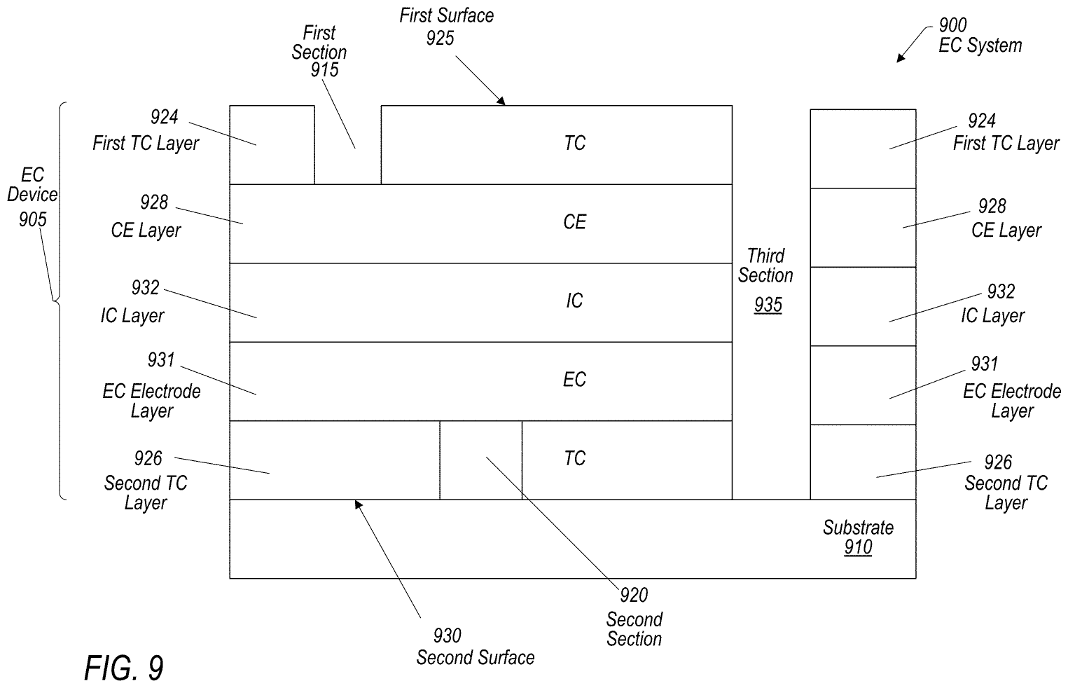

FIG. 9 illustrates a perspective view of an example EC system 900 according to some aspects of this disclosure. The EC system 900 may include one or more same or similar features as the features described with respect to or illustrated in FIGS. 1, 2, 3, 4, 5, 6A, 6B, 6C, 7, 8, 10, and 11. For example, the EC system 900 illustrated in FIG. 9 may include one or more same or similar features as the EC system 100 illustrated in FIG. 1, the system 200 illustrated in FIG. 2, the coated transparent substrate 300 illustrated in FIG. 3, and the coated transparent substrate 400 illustrated in FIG. 4, the coated transparent substrate 500 illustrated in FIG. 5, the sections illustrated in FIG. 6A, FIG. 6B, and FIG. 6C, the coated transparent substrate 700 illustrated in FIG. 7, and the EC system 800 illustrated in FIG. 8. FIG. 9, as with the other included figures, is shown for illustrative purposes and does not limit either the possible embodiments of the present invention or the claims. In some aspects, the EC system 900 may include an EC device 905 secured to a substrate 910. The EC device 905 may include a thin film which may be deposited on to the substrate 910. As shown in FIG. 9, the EC device 905 may have a first TC layer 924, a CE layer 928, an IC layer 932, an EC electrode layer 931, and a second TC layer 926. The first TC layer 924 may include a first surface 925 forming an exterior boundary of the EC device 905. Similarly, the second TC layer 926 may include a second surface 930 forming another exterior boundary of the EC device 905. The substrate 910 may be abutting the second surface 930 of the EC device 905. The substrate 910 may include one or more optically transparent materials, e.g., glass, plastic, and the like. It should be understood that the EC system 900 may additionally, or alternatively, include another substrate that is at least similar to the substrate 910. The other substrate may be abutting a first surface 925 of the first TC layer 924.

The EC system 900 may also include a first section 915 and a second section 920 each for enhancing electromagnetic communication of an electromagnetic communication band through the EC system 900. The first section 915 may extend from the first surface 925 and at least partially through the first TC layer 924. Because the first section 915 allows the first TC layer 924 to remain intact, an electric current may continue to communicate through the first TC layer 924 around the first section 815. The first section 915 may not extend into the CE layer 928. Thus, the EC device 905 may continue to provide tinting while enhancing electromagnetic communication of the first electromagnetic communication band through the first section 915. The second section 920 may extend from the second surface 930 and at least partially through the second TC layer 926. Because the second section 920 allows the second TC layer 926 to remain intact, an electric current may continue to communicate through the second TC layer 826 around the second section 820. The second section 820 may not extend into the EC electrode layer 831. Thus, the EC device 805 may continue to provide tinting while enhancing electromagnetic communication of the second electromagnetic communication band through the second section 820. The first section 815 and the second section 820 may be formed using one or more cuts or ablations as described herein. In addition, or as an alternative, at least one of the first section 815 or the second section 820 may be formed using a masking process, for example, during the formation of the first TC layer 824 and the second TC layer 826, respectively.

In addition, the EC system 900 may also include a third section 935. The third section 935 may extend at least partially through (e.g., completely through) the EC device 905 and may be the same as or at least similar to the first section 215 illustrated in FIG. 2 or the second section 220 illustrated in FIG. 2. Thus, in some aspects, in a single EC system (or a coated transparent substrate with another device), such as the EC system 900 illustrated in FIG. 9, at least one section (e.g., the first section 915 and/or the second section 920) extends partially through the EC device 905 while another section (e.g., the third section 935) may extend further through or completely through the EC device 905.

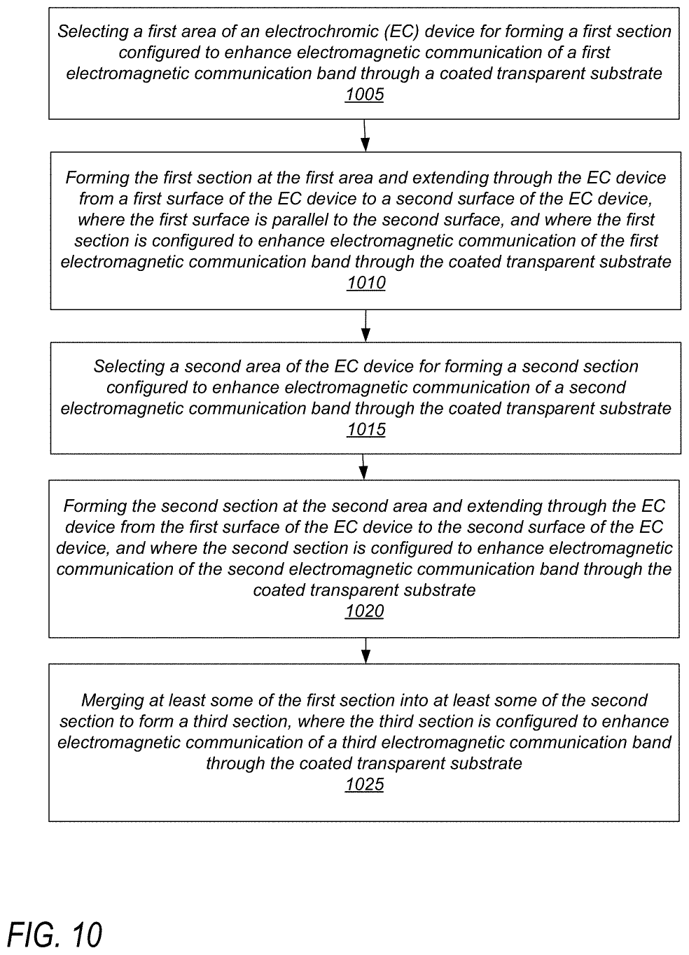

FIG. 10 illustrates an example method for manufacturing a coated transparent substrate according to some aspects of this disclosure. The method may include one or more same or similar features as the features described with respect to or illustrated in FIGS. 1, 2, 3, 4, 5, 6A, 6B, 6C, 7, 8, 9, and 11. For example, the coated transparent substrate may include one or more same or similar features as the EC system 100 illustrated in FIG. 1, the system 200 illustrated in FIG. 2, the coated transparent substrate 300 illustrated in FIG. 3, and the coated transparent substrate 400 illustrated in FIG. 4, the coated transparent substrate 500 illustrated in FIG. 5, the sections illustrated in FIG. 6A, FIG. 6B, and FIG. 6C, the coated transparent substrate 700 illustrated in FIG. 7, the EC system 800 illustrated in FIG. 8, and the EC system 900 illustrated in FIG. 9. FIG. 10, as with the other included figures, is shown for illustrative purposes and does not limit either the possible embodiments of the present invention or the claims.

As shown in block 1005, a first area of a first surface of an EC device may be selected to form at least a first section for enhancing electromagnetic communication of a first electromagnetic communication band through the coated transparent substrate. In some aspects, the first area may be selected at an area of the coated transparent substrate that is less frequently used for visible light communication (e.g., viewing) compared to another area of the coated transparent substrate. For example, the first area may include a boundary formed at a location adjacent an edge surface of the coated transparent substrate. As another example, the first area may include an area that is no more than 50 mm from an edge surface of the coated transparent substrate. In some aspects, the first area may include an obscuration area. An obscuration area may be an area of the coated transparent substrate that is not being used to communicate visible therethrough. For example, the coated transparent substrate may be intended for use as an automobile windshield. In this case, the obscuration area may include an area of the coated transparent substrate designated for attaching a rear-view mirror. As another example, the coated transparent substrate may be intended for use as an exterior window of a building. The coated transparent substrate may be installed on the exterior of the building within a frame that overlaps a perimeter area of the transparent substrate and obscures or obstructs visible light from propagating through the coated transparent substrate at the location where the frame overlaps the coated transparent substrate. In this case, the obscuration area may include an area where the frame overlaps the coated transparent substrate.

As shown in block 1010, the first section may be formed extending through the EC device from a first surface of the EC device to a second surface of the EC device. The first surface of the EC device may be parallel or substantially parallel to the second surface of the EC device. The first section may be configured to enhance electromagnetic communication of a first electromagnetic communication band through a coated transparent substrate. The first electromagnetic communication band may include 600 MHz to 960 MHz. The first section may include a low-pass or all-pass topology in two cross polarizations at the first microwave band. In some aspects, forming the first section may include cutting the EC device to form a first cut pattern extending at least partially through the EC device. The first cut pattern may be formed by one or more cuts that are no greater than 15 μm. The first cut pattern may have a first filling factor. The first filling factor may be less than 50% of the first surface. The first cut pattern may be formed with a laser having an elongated focal region that has an aspect ratio of at least 1:2. The first cut pattern may be formed with a laser having a circular focal region that has an aspect ratio that is less than 2:1. The first section may be formed at the first area including a boundary formed at a location adjacent an edge surface of the coated transparent substrate. As another example, the first section may be formed at the first area including an area that is no more than 50 mm from an edge surface of the coated transparent substrate. In some aspects, the first section may be formed at an obscuration area as described herein.

In some aspects, the first section may extend through the coated transparent substrate in a direction that is parallel to an edge surface of the coated transparent substrate. In some aspects, forming the first section may include forming the first section extending from the first top layer surface and at least partially through the top layer.

As shown in block 1015, a second area of the first surface of the EC device may be selected to form at least a second section for enhancing electromagnetic communication of a second electromagnetic communication band through the coated transparent substrate. In some aspects, the second area may be selected at an area of the coated transparent substrate that is less frequently used for visible light communication (e.g., viewing) compared to another area of the coated transparent substrate. For example, the second area may include a boundary formed at a location adjacent an edge surface of the coated transparent substrate. As another example, the second area may include an area that is no more than 50 mm from an edge surface of the coated transparent substrate. In some aspects, the second area may include an obscuration area as described herein. In some aspects, the second area may be an area that is adjacent the first area and/or an area that at least partially overlaps or merges with the first area as described herein.

As shown in block 1020, the second section may be formed extending through the EC device from the first surface of the EC device to the second surface of the EC device. The first surface of the EC device may be parallel or substantially parallel to the second surface of the EC device. The second section may be configured to enhance electromagnetic communication of a second electromagnetic communication band through a coated transparent substrate. The second electromagnetic communication band may include 2600 MHz to 3800 MHz. The second section may include a high-pass or band-pass topology in one polarization of a passband of the first section at the second microwave band. In some aspects, forming the second section may include cutting the EC device to form a second cut pattern extending at least partially through the EC device. The second cut pattern may be formed by one or more cuts that are no greater than 15 μm. The second cut pattern may have a second filling factor such that the first filling factor is twice the second filling factor. The first cut pattern may include a different pattern than the second cut pattern. The second cut pattern may be formed with a laser having an elongated focal region that has an aspect ratio of at least 1:2. The second cut pattern may be formed with a laser having a circular focal region that has an aspect ratio that is less than 2:1. The second section may be formed at the second area including a boundary formed at a location adjacent an edge surface of the coated transparent substrate. As another example, the second section may be formed at the second area including an area that is no more than 50 mm from an edge surface of the coated transparent substrate. In some aspects, the second section may be formed at an obscuration area as described herein.

In some aspects, the second section may extend through the coated transparent substrate in a direction that is parallel to an edge surface of the coated transparent substrate. In some aspects, forming the second section may include forming the second section extending from the first top layer surface and at least partially through the top layer. In some aspects, the second section may be offset from an axis extending through the first section and perpendicular to the first top layer surface.

As shown in block 1025, when forming the first section and the second section, for example, at least a portion of the first section may overlap with or be merged with at least a portion of the second section to form a merged or third section. The third section may be configured to enhance electromagnetic communication of a third electromagnetic communication band through the coated transparent substrate. The third electromagnetic communication band may include 1700 MHz to 1900 MHz. The third section may be formed extending from the first surface at an obscuration area of the coated transparent substrate. The obscuration area may include a boundary formed at a location adjacent an edge surface of the coated transparent substrate. The obscuration area may include an area on the first surface that is no more than 50 mm from an edge surface of the coated transparent substrate. In some aspects, the third section may extend through the coated transparent substrate in a direction that is parallel to an edge surface of the coated transparent substrate.

Please note that the functional block described herein are illustrated in FIG. 10 in merely one example arrangement. In other embodiments, the techniques and functionality described above may be performed using different steps in different orders or may be grouped into a different number of steps or may be performed as a single method without distinct steps.

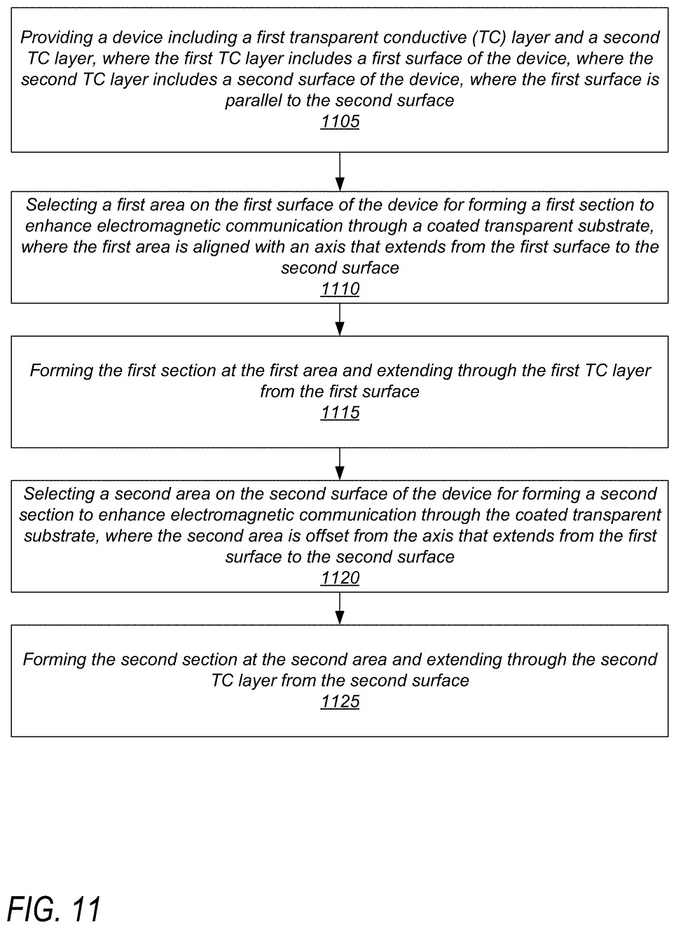

FIG. 11 illustrates another example method for manufacturing a device according to some aspects of this disclosure. The method may include one or more same or similar features as the features described with respect to or illustrated in FIGS. 1, 2, 3, 4, 5, 6A, 6B, 6C, 7, 8, 9, and 10. For example, the device may include one or more same or similar features as the EC system 100 illustrated in FIG. 1, the system 200 illustrated in FIG. 2, the coated transparent substrate 300 illustrated in FIG. 3, and the coated transparent substrate 400 illustrated in FIG. 4, the coated transparent substrate 500 illustrated in FIG. 5, the sections illustrated in FIG. 6A, FIG. 6B, and FIG. 6C, the coated transparent substrate 700 illustrated in FIG. 7, the EC system 800 illustrated in FIG. 8, and the EC system 900 illustrated in FIG. 9. The method for manufacturing the coated transparent substrate illustrated in FIG. 11 may include one or more same or similar method steps and/or one or more same or similar features described here with respect to the method for manufacturing the coated transparent substrate of FIG. 10. FIG. 11, as with the other included figures, is shown for illustrative purposes and does not limit either the possible embodiments of the present invention or the claims.

As shown in block 1105, a device (e.g., a coated device) may be provided. The device may include a first transparent conductive (TC) layer and a second TC layer. The first TC layer includes a first surface of the device. The second TC layer includes a second surface of the device. The first surface may be substantially parallel to the second surface.

As shown in block 1110, a first area of the first surface of the first TC layer may be selected to form at least a first section for enhancing electromagnetic communication through the device. In some aspects, the first area may be selected at an area of the device that is less frequently used for visible light communication (e.g., viewing) compared to another area of the device. For example, the first area may include a boundary formed at a location adjacent an edge surface of the device. As another example, the first area may include an area that is no more than 50 mm from an edge surface of the device. In some aspects, the first area may include an obscuration area. An obscuration area may be an area of the device that is not being used to communicate visible therethrough. For example, the device may be intended for use with an automobile windshield. In this case, the obscuration area may include an area of the device designated for attaching a rear-view mirror. As another example, the device may be intended for use with an exterior window of a building. The device may be installed on the exterior of the building within a frame that overlaps a perimeter area of the device and obscures or obstructs visible light from propagating through the device at the location where the frame overlaps the device. In this case, the obscuration area may include an area where the frame overlaps the device. In some aspects, the first area may include no more than 50% of the entire surface area of the first surface. In some aspects, the first area may include a plurality of different areas across the first surface of the first TC layer. The plurality of different areas may include no more than 50% of the entire surface area of the first surface. The first area may be aligned with an axis that extends through the device from first surface to the second surface and that is substantially perpendicular to at least one of the first surface or the second surface.

As shown in block 1115, a first section may be formed at the first area and extending at least partially through the first TC layer from the first surface. The first section may be configured to enhance electromagnetic communication through a device. For example, the first section may be configured to enhance electromagnetic communication of a first electromagnetic communication band through the device. The first electromagnetic communication band may include 600 MHz to 960 MHz. The first section may include a low-pass or all-pass topology in two cross polarizations at the first microwave band. In some aspects, the first section may be formed using a masking process, for example, during the formation of the first TC layer. In some aspects, forming the first section may include cutting the device to form a first cut pattern extending through the device. The first cut pattern may be formed by one or more cuts that are no greater than 15 μm. The first cut pattern may have a first filling factor. The first filling factor may be less than 50% of the first surface. The first cut pattern may be formed with a laser having an elongated focal region that has an aspect ratio of at least 1:2. The first cut pattern may be formed with a laser having a circular focal region that has an aspect ratio that is less than 2:1. The first section may be formed at the first area including a boundary formed at a location adjacent an edge surface of the device. As another example, the first section may be formed at the first area including an area that is no more than 50 mm from an edge surface of the device. In some aspects, the first section may be formed at an obscuration area as described herein. In some aspects, the first section may extend through the device in a direction that is parallel to an edge surface of the device. The first section may extend from the first surface of the first TC layer and at least partially through the first TC layer in a direction that is parallel to an edge surface of the device. The first section may be aligned with an axis that extends through the device from first surface to the second surface and that is substantially perpendicular to at least one of the first surface or the second surface. The first section may extend through the first TC layer in a direction along the axis.

As shown in block 1120, a second area of the second surface of the second TC layer may be selected to form at least a second section for enhancing electromagnetic communication through the device. In some aspects, the second area may be selected at an area of the device that is less frequently used for visible light communication (e.g., viewing) compared to another area of the device. For example, the second area may include a boundary formed at a location adjacent an edge surface of the device. As another example, the second area may include an area that is no more than 50 mm from an edge surface of the device. In some aspects, the second area may include an obscuration area. An obscuration area may be an area of the device that is not being used to communicate visible therethrough. For example, the device may be intended for use with an automobile windshield. In this case, the obscuration area may include an area of the device designated for attaching a rear-view mirror. As another example, the device may be intended for use with an exterior window of a building. The device may be installed on the exterior of the building within a frame that overlaps a perimeter area of the device and obscures or obstructs visible light from propagating through the device at the location where the frame overlaps the device. In this case, the obscuration area may include an area where the frame overlaps the device. In some aspects, the second area may include no more than 50% of the entire surface area of the second surface. In some aspects, the second area may include a plurality of different areas across the second surface of the second TC layer. The plurality of different areas may include no more than 50% of the entire surface area of the second surface. The first area may be offset from the axis that extends through the first area, from first surface to the second surface, and that is substantially perpendicular to at least one of the first surface or the second surface.

As shown in block 1125, a second section may be formed at the second area and extending through the second TC layer from the second surface. The second section may be configured to enhance electromagnetic communication through a device. For example, the second section may be configured to enhance electromagnetic communication of a second electromagnetic communication band through a device. In some aspects, the second electromagnetic communication band may be same band or share one or more same frequencies as the first electromagnetic communication band. In some aspects, the second electromagnetic communication band may include 2600 MHz to 3800 MHz. The second section may include a high-pass or band-pass topology in one polarization of a passband of the first section at the second microwave band. In some aspects, the second section may be formed using a masking process, for example, during the formation of the second TC layer. In some aspects, forming the second section may include cutting the device to form a second cut pattern extending through the coated. The second cut pattern may have a second filling factor such that the second filling factor is half the first filling factor. The second cut pattern may include a different pattern than the first cut pattern. The second cut pattern may be formed with a laser having an elongated focal region that has an aspect ratio of at least 1:2. The second cut pattern may be formed with a laser having a circular focal region that has an aspect ratio that is less than 2:1. As another example, the second section may be formed at the second area including an area that is no more than 50 mm from an edge surface of the device. In some aspects, the second section may be formed at an obscuration area as described herein. The second section may be formed at the second area including a boundary formed at a location adjacent an edge surface of the device. In some aspects, the second section may extend through the device in a direction that is parallel to an edge surface of the device. The second section may extend from the second surface of the second TC layer and at least partially through the second TC layer in a direction that is parallel to an edge surface of the second TC layer. The second section may be offset from the axis that is aligned with the first area and the first section. The second section may extend through the second TC layer in a direction that is parallel to the axis.

Please note that the functional block described herein are illustrated in FIG. 11 in merely one example arrangement. In other embodiments, the techniques and functionality described above may be performed using different steps in different orders or may be grouped into a different number of steps or may be performed as a single method without distinct steps.

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A device for enhanced electromagnetic communication through a coated transparent substrate, comprising:
a first transparent conductive (TC) layer and a second TC layer, wherein the first TC layer comprises a first surface, wherein the second TC layer comprises a second surface, and wherein the first surface is parallel to the second surface;
a first section extending through the first TC layer from the first surface and aligned with an axis that extends from the first surface to the second surface, wherein the first section is configured to enhance electromagnetic communication of through the coated transparent substrate; and
a second section extending through the second TC layer from the second surface and offset from the axis that extends from the first surface to the second surface, wherein the second section is configured to enhance electromagnetic communication through the coated transparent substrate.

2. The device of claim 1, wherein the first section and the second section each comprise one or more cuts forming a cut pattern.

3. The device of claim 2, wherein the cut pattern comprises a filling factor that is less than 50% of the first surface and that is less than 50% of the second surface.

4. The device of claim 2, wherein the cut pattern comprises one or more cuts that are each no greater than 15 μm wide.

5. The device of claim 1, further comprising:
a counter electrode (CE) layer positioned adjacent the first TC layer, an EC electrode layer positioned adjacent the second TC layer, and an ionic conductive (IC) layer positioned between the CE layer and the EC electrode layer, wherein the first section does not extend into CE layer and the second section does not extend into the EC electrode layer.

6. The device of claim 1, wherein:
the first section occupies an entire area of the first surface; and
the second section occupies an entire area of the second surface.

7. The device of claim 1, wherein the first section is configured to enhance electromagnetic communication of a first electromagnetic communication band through the coated transparent substrate, wherein the second section is configured to enhance electromagnetic communication of a second electromagnetic communication band through the coated transparent substrate, and wherein the first electromagnetic communication band comprises one or more electromagnetic communication frequencies that are different from one or more electromagnetic communication frequencies of the second electromagnetic communication band.

8. The device of claim 7, wherein:
the first section comprises one or more cuts forming a first cut pattern; and
the second section comprises one or more cuts forming a second cut pattern.

9. The device of claim 8, wherein the one or more cuts forming the first cut pattern and the one or more cuts forming the second cut pattern are each no greater than 15 μm.

10. The device of claim 7, wherein at least one of the first electromagnetic communication band and the second electromagnetic communication band comprises at least one of 600 MHz to 960 MHz, 1700 MHz to 1900 MHz, or 2600 MHz to 3800 MHz.

11. A coated system for enhanced electromagnetic communication, comprising:
an optically transparent substrate;
a device including a first transparent conductive (TC) layer and a second TC layer, wherein the first TC layer comprises a first surface in contact with the optically transparent substrate, wherein the second TC layer comprises a second surface, and wherein the first surface is parallel to the second surface;
a first section extending through the first TC layer from the first surface and aligned with an axis that extends from the first surface to the second surface, wherein the first section is configured to enhance electromagnetic communication through the coated system; and
a second section extending through the second TC layer from the second surface and offset from the axis that extends from the first surface to the second surface, wherein the second section is configured to enhance electromagnetic communication through the coated system.

12. A method for manufacturing a device to enhance electromagnetic communication through a coated transparent substrate, comprising:
providing the device including a first transparent conductive (TC) layer and a second TC layer, wherein the first TC layer comprises a first surface, wherein the second TC layer comprises a second surface, and wherein the first surface is parallel to the second surface;
forming a first section extending through the first TC layer from the first surface and aligned with an axis that extends from the first surface to the second surface, wherein the first section is configured to enhance electromagnetic communication through the coated transparent substrate; and
forming a second section extending through the second TC layer from the second surface and offset from the axis that extends from the first surface to the second surface, wherein the second section is configured to enhance electromagnetic communication through the coated transparent substrate.

13. The method of claim 12, wherein:
the first section comprises one or more cuts forming a first cut pattern; and
the second section comprises one or more cuts forming a second cut pattern.

14. The method of claim 13, wherein:
the first cut pattern comprises a filling factor that is less than 50% of the first surface; and
the first cut pattern comprises a filling factor that is less than 50% of the second surface.

15. The method of claim 13, wherein each of the first cut pattern and the second cut pattern comprises one or more cuts that are each no greater than 15 μm wide.

16. The method of claim 13, wherein the first cut pattern is formed with a laser having an elongated focal region that has an aspect ratio of at least 1:2.

17. The method of claim 13, wherein the first cut pattern is formed with a laser having a circular focal region that has an aspect ratio that is less than 2:1.

18. The method of claim 13, wherein the second cut pattern is formed with a laser having an elongated focal region that has an aspect ratio of no more than 2:1.

19. The method of claim 12, wherein the first section is configured to enhance electromagnetic communication of a first electromagnetic communication band through the coated transparent substrate, wherein the second section is configured to enhance electromagnetic communication of a second electromagnetic communication band through the coated transparent substrate, and wherein at least one of the first electromagnetic communication band and the second electromagnetic communication band comprises at least one of 600 MHz to 960 MHz, 1700 MHz to 1900 MHz, or 2600 MHz to 3800 MHz.

20. The method of claim 19, wherein the first electromagnetic communication band and the second electromagnetic communication band comprise one or more same electromagnetic communication frequencies.
